(19) United States
(12) Patent Application Publication
(10) Pub. No.: US 2018/0133795 A1
(43) Pub. Date: May 17, 2018

(54) LOW CARBON STEEL ALLOY COMPOSITION, POWDERS, AND METHOD FOR FORMING OBJECT CONTAINING THE SAME

(71) Applicant: INDUSTRIAL TECHNOLOGY RESEARCH INSTITUTE, Hsinchu (TW)

(72) Inventors: Chih-Jung WENG, Tainan City (TW); Chih-Chao YANG, Tainan City (TW); Yu-Hsien CHOU, Tainan City (TW); Shun-Huei WANG, Tainan City (TW)

(73) Assignee: INDUSTRIAL TECHNOLOGY RESEARCH INSTITUTE, Hsinchu (TW)

(21) Appl. No.: 15/393,894

(22) Filed: Dec. 29, 2016

(30) Foreign Application Priority Data
Nov. 15, 2016 (TW) 105137254

(51) Int. Cl. B22F 3/105; B33Y 10/00; B33Y 70/00; B33Y 80/00; B22F 1/00; B22F 9/08; C22C 38/18; C22C 38/02

(52) U.S. Cl. CPC B22F 3/1055; B33Y 10/00; B33Y 70/00; B33Y 80/00; B22F 1/0003; B22F 2998/10; C22C 38/18; C22C 38/02; B22F 2301/35; B22F 2303/01; B22F 2304/10; B22F 9/082

(57) ABSTRACT

Disclosed is an low carbon steel alloy composition, including 98.5 to 99.7 parts by weight of Fe, 0.1 to 0.3 parts by weight of C, 0.1 to 0.6 parts by weight of Si, and 0.15-0.45 parts by weight of Cr. The low carbon steel alloy composition can be sprayed by gas to form powders, which are sintered by laser additive manufacturing to form a sintered object.

This application claims the benefit of Taiwan application Serial No. 105137254, filed Nov. 15, 2016, the subject matter of which is incorporated herein by reference.

### TECHNICAL FIELD

The technical field relates to a low carbon steel alloy composition and a method for forming the objects containing the same.

### BACKGROUND

Additive Manufacturing (AM) has been evaluated as the third industrial revolution, providing new challenges and changes for industries of molding, aerospace technology components, tools, and etc. Metal additive manufacturing not only can reduce the manufacturing processing steps of traditional metal industry but also has advantages of forming semi-finished products with near-net shapes; further, there is not restriction to the geometric structures of the products. Currently, subtractive manufacturing is still the mainstream of industrial molding; however, compared to traditional manufacturing processes, additive manufacturing applied in producing cores/molds has advantages of reduction of complicated manufacturing processing steps and capable of producing objects with complicated geometric shapes, solving the geometric design problems that couldn't be overcome due to the restriction of subtractive manufacturing. As such, industrial cores/molds with high functionality and high lifetime can be manufactured through more flexible geometric designs; for example, water routes with special shapes can be designed within a mold interior for effectively dissipating heats generated during treatments, increasing production stabilities and performance, and further increasing industry competitiveness.

Traditional low carbon steel materials contain relatively high amounts of manganese (Mn), which easily evaporates after laser sintering, thus directly influencing the mechanical strength and toughness of the as-formed carbon steel materials. When low carbon steel alloy powders with high circularity and high flowing property are used for laser additive manufacturing, the as-formed objects have better mechanical properties and hardness than that of traditional low carbon steel materials.

Therefore, developments of low carbon steel alloy compositions suitable for laser additive manufacturing have become one of the goals that industries are working on.

### SUMMARY

According to the present disclosure, a low carbon steel alloy composition and a method for forming an object containing the same is provided.

One embodiment of the present disclosure provides a low carbon steel alloy composition including 98.5-99.7 parts by weight of iron (Fe), 0.1-0.3 parts by weight of carbon (C), 0.1-0.6 parts by weight of silicon (Si) and 0.15-0.45 parts by weight of chromium (Cr).

In another embodiment of the present disclosure, the low carbon steel alloy composition may further include trace amount of Mn; for example, less than 0.1 parts by weight of Mn.

According to the present disclosure, a gas spraying method for forming powders from the low carbon steel alloy composition is further provided. In one embodiment, the particle diameter of the powders is 5 μm to 200 μm.

According to the disclosure of the present disclosure, after the powders are formed from the low carbon steel alloy composition, an object is formed from the powders by a laser additive manufacturing method, a plasma spraying method, an arc spraying method, and etc.

Detailed description of the present disclosure is described hereinafter. Specific details disclosed in the embodiments are for examples and for explaining the disclosure only and are not to be construed as limitations. One of ordinary skill in the art may understand other advantages and effects of the present disclosure. The present disclosure can be realized or used in terms of different exemplary embodiment(s). The details of the present disclosure may also be modified or changed according to different views and applications, and the scope of the present disclosure should be accorded the broadest interpretation so as to encompass all such modifications and similar arrangements and procedures.

### BRIEF DESCRIPTION OF THE DRAWINGS

FIG. 1 shows a SEM picture of powders made of a low carbon steel alloy composition according to an embodiment of the present disclosure;

FIG. 2 shows an object manufactured by laser additive manufacturing sintering of powders made of a low carbon steel alloy composition according to an embodiment of the present disclosure;

FIG. 3 shows a cross-sectional phase diagram of an object manufactured by laser additive manufacturing sintering of powders made of a low carbon steel alloy composition according to an embodiment of the present disclosure;

FIG. 4 shows an object manufactured by laser additive manufacturing sintering of traditional low carbon steel powders according to a comparative embodiment; and

FIG. 5 shows a cross-sectional phase diagram of an object manufactured by laser additive manufacturing sintering of traditional low carbon steel powders according to a comparative embodiment.

### DETAILED DESCRIPTION

In the description hereinafter, according to the disclosure of the present disclosure, a low carbon steel alloy powder material, which is made of a low carbon steel alloy composition, for laser additive manufacturing is developed. The main component of the composition is iron (Fe), and with the designs of each of the components and the additions of trace amounts of element, e.g. carbon (C), silicon (Si), chromium (Cr), and etc. in the alloy composition, the evaporation of element(s) with low melting point(s) (high vapor pressure) during the laser sintering process of the powders can be prevented. As such, the density and mechanical properties of the as-formed object(s) is not influenced, and mechanical strength of the low carbon steel alloy object can be further improved.

The temperature of the melting pool of the laser additive manufacturing is very high and up to 2500° C. to 3000° C., and such temperature may cause elements with high vapor pressure in the material to evaporate, further causing generation of pores within the as-formed objects, reduction of mechanical properties, and contamination of instrumental cabins. Therefore, according to the disclosure of the present disclosure, the alloy composition adopts Fe as the main component of the alloy material with additions of enhancement elements with low vapor pressures, e.g. elements C, Si, Cr, and etc.

According to the disclosure of the present disclosure, the particle diameter of the powders made of the low carbon steel alloy composition is 15 μm to 60 μm, such that evaporation of elements in the laser additive manufacturing sintering process does not occur, and thus the strength of the as-formed object is superior than that made of traditional low carbon steel powders.

In an embodiment of the present disclosure, the low carbon steel alloy composition includes 98.5 to 99.7 parts by weight of Fe, 0.1 to 0.3 parts by weight of C, 0.1 to 0.6 parts by weight of Si, and 0.15-0.45 parts by weight of Cr. In another embodiment, the amount of Fe may be 98.7 to 99.5 parts by weight.

Manufacturing powders of the low carbon steel alloy composition

### Embodiments 1-6

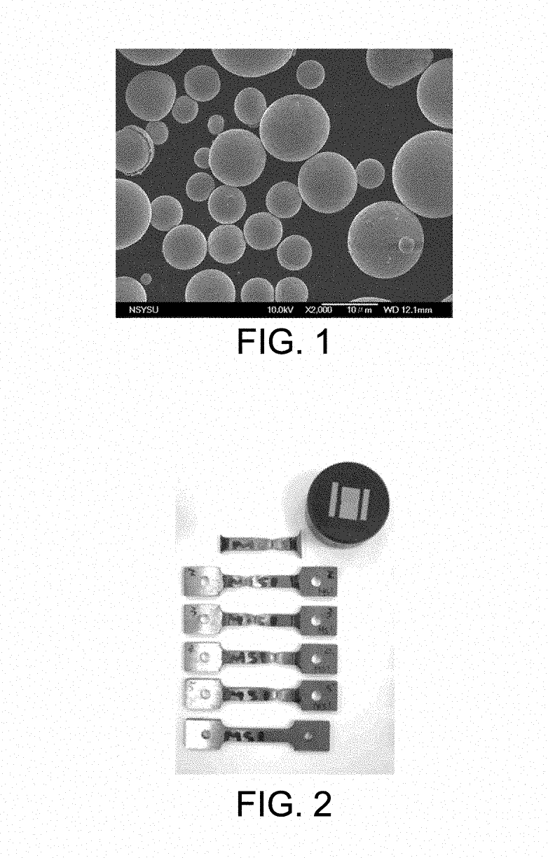

The weight ratios of elements Cr, C, Si and Fe are as shown in table 1. The compositions are sintered by a vacuum sintering method, wherein a high-frequency heater (V-UTMOST-SPZ-110) with a frequency of 1-20 KHz and a temperature of 1400-1600° C. is used for the high-frequency sintering process. Next, powders of the low carbon steel alloy compositions are obtained by using a gas spraying technology. The powders are spherical as shown in FIG. 1, which is a SEM picture (SEM, JEOL-6330). A laser diameter analyzer (Malvern, Mastersizer 2000E) is used for analyzing the particle diameter distribution, and the obtained results are as shown in table 1. It is to be noted that one of ordinary skill in the art understands that based on the raw materials of each of the elements selected and used, the as-made compositions may contain trace amounts of impurity elements other than the pre-determined and designed elements with pre-determined weight ratios, and these impurity elements may be originally existed in the raw materials. In one embodiment, the total amount of the impurity is less than 0.2 parts be weight.

TABLE 1

| | Fe | Cr | C | Si | Mn | D50 (μm) |
|---|---|---|---|---|---|---|
| Comparative | 98.825 | 0.05 | 0.107 | 0.58 | 0.438 | 31.62 |
| embodiment | | | | | | |
| Embodiment 1 | 99.5 | 0.15 | 0.25 | 0.1 | — | 27.808 |
| Embodiment 2 | 99 | 0.15 | 0.25 | 0.6 | — | 27.892 |
| Embodiment 3 | 99.35 | 0.3 | 0.25 | 0.1 | — | 25.58 |
| Embodiment 4 | 98.85 | 0.3 | 0.25 | 0.6 | — | 25.746 |
| Embodiment 5 | 99.2 | 0.45 | 0.25 | 0.1 | — | 26.8 |
| Embodiment 6 | 98.7 | 0.45 | 0.25 | 0.6 | — | 27.235 |

Manufacturing of object containing the powders of the low carbon steel alloy compositions

### Embodiments 7-12

The powders of embodiments 1-6 are sintered and shaped by a laser additive manufacturing method with a temperature of 2500-3000° C. for obtaining objects 1-6, wherein the laser power is 195 W/scan, and the scan rate is 750 mm/sec.

The results of the tensile strength (YS), the yielding strength (UTS), the elongation percentage (EL), and the average hardness of objects 1-6 are illustrated in table 2. The tensile strength (YS), the yielding strength (UTS) and the elongation percentage (EL) are measured by Gleeble3500 at room temperature according to ASTM E8 regulations. The average hardness is measured by Vickers-Hardness Meter to perform a HV standard hardness measurement according to ASTM E18 regulations.

TABLE 2

| | Tensile | Yielding | | Average |
|---|---|---|---|---|
| | Strength | Strength | Elongation | Hardness |
| | (Mpa) | (Mpa) | Percentage | Hv |
| Comparative | 426.3 | 526.1 | 10.30% | 231.4 |
| embodiment | | | | |
| Embodiment 1 | 700.8 | 405.3 | 11.60% | 230.59 |
| Embodiment 2 | 775.6 | 455.1 | 10.50% | 241.56 |
| Embodiment 3 | 890.4 | 452.3 | 11.20% | 278.69 |
| Embodiment 4 | 925.4 | 500.6 | 10.30% | 296.42 |
| Embodiment 5 | 1027.2 | 510.1 | 11.70% | 325.68 |
| Embodiment 6 | 1030.1 | 536.5 | 10.60% | 341.32 |

### Comparative Embodiment

The weight ratios of elements Cr, C, Si, Fe and Mn are as shown in table 1. The composition is sintered by a vacuum sintering method, wherein a high-frequency heater (V-UTMOST-SPZ-110) with a power of 15-25 kW and a temperature of 1400-1600° C. is used for the high-frequency sintering process. Next, powders of the composition are obtained by using a gas spraying technology.

An object of the powders of the comparative example is manufactured according to the same method as that used for manufacturing the objects of embodiments 7-12. The tensile strength (YS), the yielding strength (UTS), the elongation percentage (EL), and the average hardness of the object of the comparative embodiment are illustrated in table 2.

As shown in table 2, the object manufactured from the powders of the low carbon steel alloy composition according to the disclosure has better mechanical properties and hardness than those of the object of the comparative embodiment (commercial available product); particularly, the objects made according to the present disclosure has much greater tensile strength than that of the object of the comparative embodiment.

As shown in FIGS. 2 and 4, it is apparent that pores and defects are not generated from the evaporation of element Mn within the object interior during the sintering of the powders of the low carbon steel alloy compositions, thereby the objects made according to the present disclosure have better density and mechanical strength, and of which the resistance to permanent deformation and destruction under external force is much better than that of the object of the comparative embodiment (commercial product S10C).

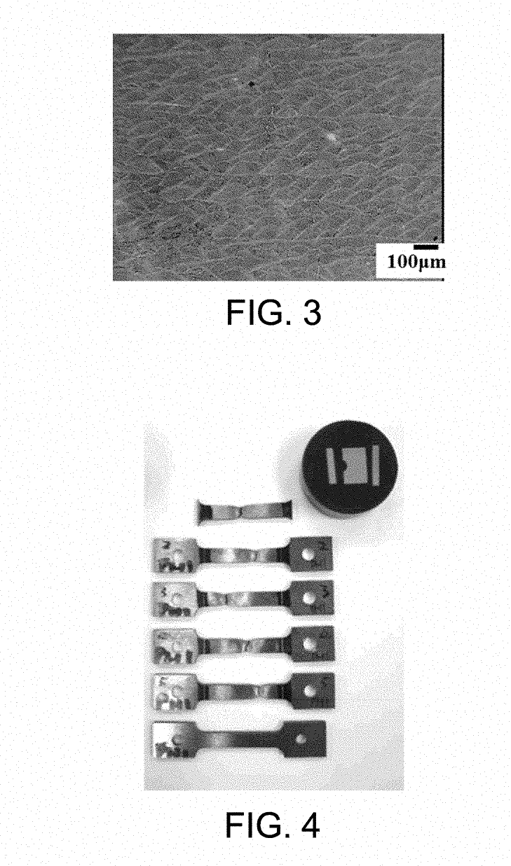

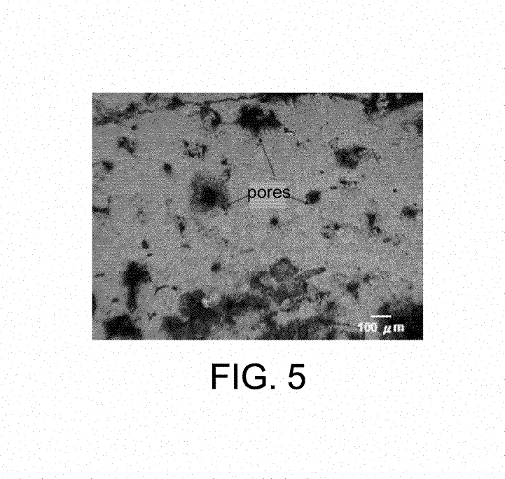

In addition, as shown in the cross-sectional phase diagrams in FIGS. 3 and 5, the sintered material of the present disclosure has a structure with highly refined grains, and these refined grains are provided with more grain boundaries within the metal structure. These grain boundaries have effects of blocking shifting and deformation, such that the metal material can be strengthened, and the toughness of the material can be further improved.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A low carbon steel alloy composition, comprising:
0. 1-0.3 parts by weight of carbon;
0. 1-0.6 parts by weight of silicon;
0. 15-0.45 parts by weight of chromium; and
98. 5-99.7 parts by weight of iron.

2. The low carbon steel alloy composition according to claim 1, wherein iron is in an amount of 98.7-99.5 parts by weight.

3. The low carbon steel alloy composition according to claim 1, further comprising:
less than 0.2 parts by weight of an impurity.

4. A manufacturing method of an alloy object, comprising:
forming powders from the low carbon steel alloy composition according to claim 1 by a gas spraying method; and
sintering the powders by a laser additive manufacturing (AM) method for forming the alloy object.

5. The manufacturing method according to claim 4, wherein a particle diameter of the powders is 15 μm to 60 μm.

6. The manufacturing method according to claim 4, wherein a temperature of the laser additive manufacturing method is 2500° C. to 3000° C.
